(19) United States
(12) Patent Application Publication
(10) Pub. No.: US 2015/0294639 A1
(43) Pub. Date: Oct. 15, 2015

(54) METHOD AND SYSTEM FOR SWITCHING A MODE OF AN ELECTRONIC DEVICE

(71) Applicants: SONY CORPORATION, Tokyo (JP); SONY NETWORK ENTERTAINMENT INTERNATIONAL LLC, Los Angeles, CA (US)

(72) Inventors: Charles McCoy, Coronado, CA (US); Justin Gonzales, San Diego, CA (US); True Xiong, San Diego, CA (US)

(73) Assignees: SONY CORPORATION, Tokyo (JP); SONY NETWORK ENTERTAINMENT INTERNATIONAL LLC, Los Angeles, CA (US)

(21) Appl. No.: 14/252,287

(22) Filed: Apr. 14, 2014

(51) Int. Cl. G09G 5/00; G06F 3/01; G06F 3/16; G06F 3/041

(52) U.S. Cl. CPC G09G 5/003; G06F 3/041; G06F 3/017; G06F 3/167; G06F 3/016; G09G 2354/00; G09G 2370/22; G09G 2360/144

(57) ABSTRACT

Various aspects of a method and a system for switching a mode of an electronic device are disclosed herein. The method includes switching the electronic device from a first mode to a second mode in response to detecting one or more conditions. The method further includes outputting a second response in the second mode in response to a user input provided by a user. The second response corresponds to a first response in the first mode.

### FIELD

Various embodiments of the disclosure relate to switching a mode of an electronic device. More specifically, various embodiments of the disclosure relate to switching an Input/output (I/O) mode of an electronic device.

### BACKGROUND

Conventionally, a user interacts with an electronic device either via an audio interface or a visual interface. For a user interaction performed via the audio interface, the user may require audio-based components, such as speakers or headphones. Similarly, for the user interaction via the visual interface, the user may require a graphical user interface (GUI) displayed on a display screen of the electronic device.

In certain scenarios, it may be difficult for the user to interact with the electronic device in either of the modes due to one or more environmental conditions. For example, in an environment where an ambient noise is too loud, the user may not be able to listen to an audio output. Similarly, in an environment where an ambient illumination is too high, the user may not be able to properly view the GUI of the electronic device.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and a system are provided for switching a mode of an electronic device substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for switching a mode of an electronic device, in accordance with an embodiment of the disclosure.

FIG. 2 is a block diagram illustrating an electronic device, in accordance with an embodiment of the disclosure.

FIGS. 3A and 3B illustrate a first exemplary scenario for implementing the disclosed method and system, in accordance with an embodiment of the disclosure.

FIGS. 4A and 4B illustrate a second exemplary scenario for implementing the disclosed method and system, in accordance with an embodiment of the disclosure.

FIG. 5 is a flow chart illustrating a method for switching a mode of an electronic device, in accordance with an embodiment of the disclosure.

### DETAILED DESCRIPTION

The following described implementations may be found in a method and a system for switching a mode of an electronic device. Exemplary aspects of the disclosure may comprise a method that may comprise switching the electronic device from a first mode to a second mode, in response to detecting one or more conditions. The method may further comprise outputting a second response in the second mode in response to a user input provided by a user. The second response may correspond to a first response in the first mode.

In an embodiment, the method may comprise performing an action and generating the second response, which corresponds to the user input. An association between the action and the user input may be pre-configured by the user in the first mode. In an embodiment, the method may comprise comparing one or more parameters associated with the one or more conditions with corresponding pre-determined threshold values. In an embodiment, the switching from the first mode to the second mode may be based on the comparison.

In an embodiment, the one or more conditions may comprise one or more of ambient light, ambient noise, motion detection, a battery usage status, a power supply status, and/or the like. In an embodiment, the user input may be one of an audio-based input, a touch-based input, a gesture-based input, and/or the like.

In an embodiment, the first mode may be a visual mode and the second mode may be a non-visual mode. In an embodiment, the method may comprise turning off a display of the electronic device in the non-visual mode. In an embodiment, the method may comprise indicating in the second mode that the electronic device is being switched to the second mode. The indication may include one or more of an audio-based output or a tactile output.

In an embodiment, the first mode may be a non-visual mode and the second mode may be a visual mode. In an embodiment, the method may comprise indicating in the second mode that the electronic device is being switched to the second mode. The indication may include one or more of a message and/or a graphical icon.

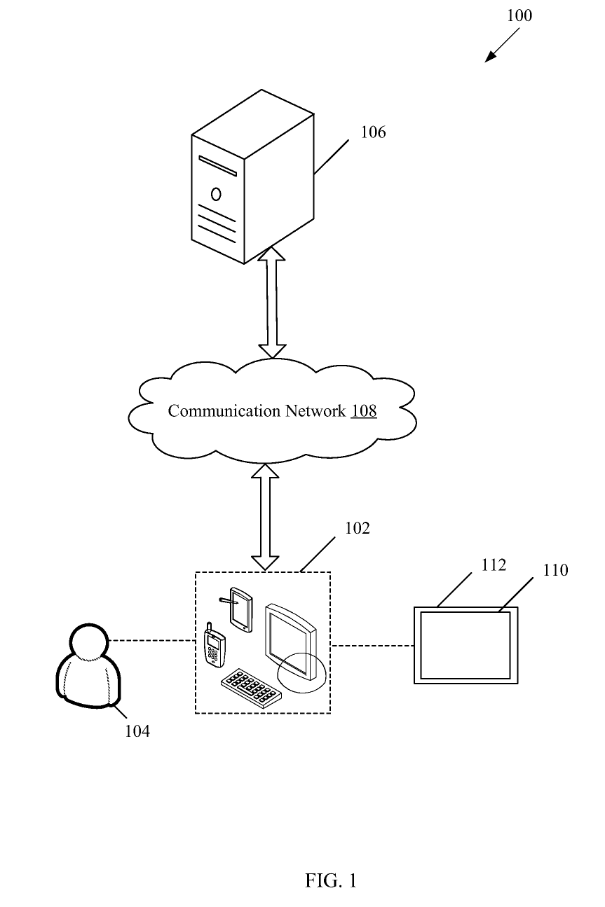

FIG. 1 is a block diagram illustrating a network environment 100, in accordance with an embodiment of the disclosure. With reference to FIG. 1, the network environment 100 may include a plurality of electronic devices, such as an electronic device 102, a user 104 associated with the electronic device 102, a service provider 106, a communication network 108, a graphical user interface (GUI) 110, and a display screen 112.

The electronic device 102 may include suitable logic, circuitry, interfaces, and/or code that may be operable to receive an input from the user 104, respond to the input provided by the user 104, and play an output to the user 104, based on the received input. The electronic device 102 may be communicatively coupled with another electronic device (not shown) and the service provider 106, via the communication network 108. The electronic device 102 may be operable to execute an application via the GUI 110, displayed on the display screen 112 of the electronic device 102. Examples of the electronic device 102 may include, but are not limited to, laptops, tablet computers, smartphones, televisions, and Personal Digital Assistant (PDA) devices.

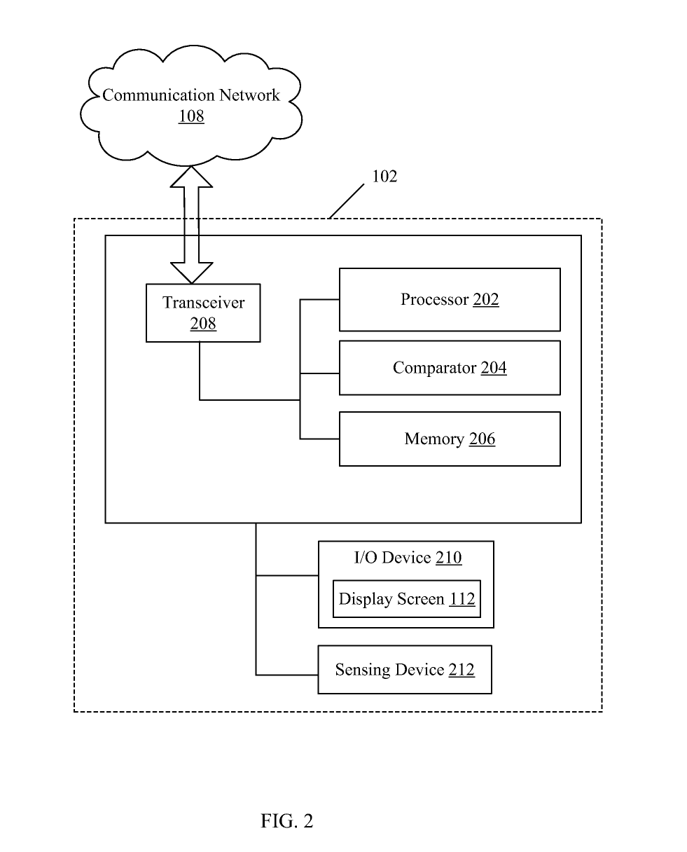

In an embodiment, the electronic device 102 may be operable to execute an application via a graphical user interface (GUI) 110 displayed on a display screen 112 of the electronic device 102. Examples of the application may include, but are not limited to, an internet-based messaging application, an online shopping application, an internet-based auction, an audio-visual conference, a multi-player game, a live video session, a live chat session, and/or the like. Although the plurality of electronic devices may have similar logic, circuitry, interfaces, and/or code, for brevity, only the electronic device 102 is described in further detail in FIG. 2.

The service provider 106 may comprise suitable logic, circuitry, interfaces, and/or code that may be operable to host and stream one or more web-based applications to the electronic device 102. Such one or more web-based applications may be streamed to the electronic device 102, based on a request received from the user 104. Examples of the one or more web-based applications may include, but are not limited to, webmail, online retail sales, online auctions, wikis, audio-visual conferences, multi-player games, live video sessions, live chat sessions, and/or the like. Such web-based applications may be reliant on a web browser, for example, the GUI 110, displayed on the display screen 112, to execute the one or more web-based applications hosted by the service provider 106.

In an embodiment, the service provider 106 may be implemented as a part of a server cloud. In another embodiment, the service provider 106 may be accessed and managed by a third party. In an embodiment, the service provider 106 may be configured to serve multimedia-on-demand to a requesting device, for example, the electronic device 102.

The communication network 108 may include a medium through which the electronic device 102 may communicate with another of the plurality of electronic devices, the service provider 106, and the social networking server. Examples of the communication network 108 may include, but are not limited to, the Internet, a Wireless Fidelity (Wi-Fi) network, a Wireless Local Area Network (WLAN), a Local Area Network (LAN), a telephone line (POTS), and/or a Metropolitan Area Network (MAN). The electronic device 102, the service provider 106, and the social networking server in the network environment 100 may be operable to communicate via the communication network 108, in accordance with various wired and wireless communication protocols, such as, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The GUI 110 may be operable to enable the user 104 to access, retrieve, view, and/or execute applications hosted by a plurality of application servers, for example, the service provider 106. In an embodiment, the GUI 110 may further enable the user 104 to access, retrieve, view, and/or execute offline applications stored in a local memory of the electronic device 102. The GUI 110, which corresponds to the executed applications, may be presented on the display screen 112 of the electronic device 102. In an embodiment, the user 104 may install a software application (not shown) on the electronic device 102, to display the GUI 110.

The display screen 112 may comprise suitable logic, circuitry, interfaces, and/or code that may be operable to provide a display of the GUI 110. The display screen 112 may be further operable to render display of one or more features and/or applications of the electronic device 102. In an embodiment, the display screen 112 may be operable to receive an input from the user 104, via a touch-sensitive screen. The display screen 112 may be realized through several known technologies, such as, but not limited to, Liquid Crystal Display (LCD) display, Light Emitting Diode (LED) display, Organic LED (OLED) display technology, CRT, and/or the like.

In an embodiment, the network environment 100 may further include a social networking server (not shown) that may comprise suitable logic, circuitry, interfaces, and/or code that may be operable to host at least one social networking website. The social networking server may provide social networking services to the electronic device 102. Notwithstanding, the disclosure may not be so limited, and other social networking websites may be hosted without limiting the scope of the disclosure. It may be appreciated by one skilled in the art that the disclosed embodiments can be implemented for a larger number of servers, service providers, electronic devices, and associated users in the network environment 100.

In operation, the electronic device 102 may be operable to execute an application requested by the user 104. In an embodiment, the application may be hosted by the service provider 106. The service provider 106 may be communicatively coupled with the electronic device 102, via the communication network 108. The electronic device 102 may be operable to execute the application in a first mode. The electronic device 102 may be operable to detect one or more conditions and one or more parameters associated with the one or more conditions. The one or more parameters associated with the one or more conditions may be compared with corresponding pre-determined threshold values stored in a local memory. Based on the comparison, the electronic device 102 may be operable to switch from the first mode to a second mode. The electronic device 102 may be further operable to indicate in the second mode that the electronic device 102 is switched to the second mode. The indication may include one or more of an audio-based output, a tactile output, a message, a graphical icon, and/or the like.

The user 104 may provide a user input to the electronic device 102 in the second mode. In response to the user input, the electronic device 102 may be operable to output a second response in the second mode. The second response may correspond to a first response in the first mode.

The electronic device 102 may be further operable to perform an action and generate the second response, which corresponds to the user input. An association between the action and the user input may be pre-configured by the user 104, while in the first mode. In an embodiment, the first mode may be a visual mode and the second mode is a non-visual mode. In another embodiment, the first mode may be a non-visual mode and the second mode is a visual mode.

FIG. 2 is a block diagram illustrating an electronic device, in accordance with an embodiment of the disclosure. FIG. 2 is explained in conjunction with elements from FIG. 1. With reference to FIG. 2, there is shown the electronic device 102. The electronic device 102 may include one or more processors, such as a processor 202, a presentation engine 202a, a comparator 204, a memory 206, a transceiver 208, one or more Input-Output (I/O) devices, such as an I/O device 210, and one or more sensing devices, such as a sensing device 212.

The processor 202 may be communicatively coupled to the memory 206, and the I/O device 210. Further, the transceiver 208 may be communicatively coupled to the processor 202, the memory 206, the I/O device 210, and the sensing device 212.

The processor 202 may comprise suitable logic, circuitry, interfaces, and/or code that may be operable to execute a set of instructions stored in the memory 206. The processor 202 may be implemented based on a number of processor technologies known in the art. Examples of processor 202 may be an X86-based processor, a Reduced Instruction Set Computing (RISC) processor, an Application-Specific Integrated Circuit (ASIC) processor, a Complex Instruction Set Computing (CISC) processor, or any other processor.

The comparator 204 may comprise suitable logic, circuitry, interfaces, and/or code that may be operable to perform a comparison of one or more parameters associated with one or more detected conditions with corresponding pre-determined threshold values. The corresponding pre-determined threshold values may be retrieved from the memory 206 by the processor 202 and transmitted to the comparator 204. The comparator 204 may be implemented based on a number of processor technologies known in the art. Examples of comparator 204 may be an X86-based processor, a Reduced Instruction Set Computing (RISC) processor, an Application-Specific Integrated Circuit (ASIC) processor, a Complex Instruction Set Computing (CISC) processor, or any other processor.

The memory 206 may comprise suitable logic, circuitry, interfaces, and/or code that may be operable to store the received set of instructions. The memory 206 may be further operable to store one or more pre-determined threshold values, which correspond to one or more parameters associated with the one or more conditions. The memory 206 may further include an application storage operable to store a repository that may include one or more multimedia applications, such as Flash player®, which may be operable to play one or more multimedia files, such as a movie. The application storage may be realized by using various multimedia database management systems that are well known to those skilled in the art. The memory 206 may be implemented based on, but not limited to, a Random Access Memory (RAM), a Read-Only Memory (ROM), a Hard Disk Drive (HDD), a storage server and/or a Secure Digital (SD) card.

The transceiver 208 may comprise suitable logic, circuitry, interfaces, and/or code that may be operable to communicate with the service provider 106, via various communication interfaces. The transceiver 208 may implement known technologies for supporting wired or wireless communication with the communication network 108. The transceiver 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 208 may communicate via wireless communication with networks, such as the Internet, an Intranet and/or a wireless network, such as a cellular telephone network, a wireless local area network (LAN) and/or a metropolitan area network (MAN), and/or other devices. The wireless communication may use any of a plurality of communication standards, protocols and technologies including, but not limited to, Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 210 may comprise various input and output devices that may be operable to communicate with the processor 202. Examples of the input devices may include, but are not limited to, a keyboard, a mouse, a joystick, a touch screen, a microphone, a camera, a motion sensor, a light sensor, and/or a docking station. Examples of the output devices may include, but are not limited to, the display screen 112, and/or a speaker.

The sensing device 212 may comprise suitable logic, circuitry, and/or interfaces that may be operable to store a machine code and/or a computer program having at least one code section executable by the processor 202 to receive and respond to a signal when touched or activated. Such a signal may comprise a touch-based input, a touchless input and/or an audio-based input.

In an embodiment, the sensing device 212 may include one or more sensors configured to detect one or more parameters associated with one or more conditions. The one or more conditions, for example, ambient light, ambient noise, motion detection, a battery usage status, and/or power supply status, may be detected with respect to the electronic device 102.

In an embodiment, the sensing device 212 may be further operable to detect the touch-based input, (such as a button-press), and the touchless input, (such as a gesture-based input), provided by the user 104. In an embodiment, the sensing device 212 may include a microphone operable to detect a voice pattern of the user 104. Such a voice pattern of the user 104 may correspond to the audio-based input.

In an embodiment, the sensing device 212 may include an accelerometer and/or a gyrometer, configured to detect orientation, angular momentum, directional movement of the electronic device 102. In an embodiment, the sensing device 212 may include one or more photosensors and/or photodetectors, for example an ambient light sensor (ALS) configured to detect ambience illumination with respect to the electronic device 102. In an embodiment, the sensing device 212 may include a microphone, such as AN-9001 Ambient Noise Sensing Microphone, configured to detect ambient noise. In an embodiment, the sensing device 212 may include one or more sensors to detect battery usage status and power supply status of the electronic device 102. In an embodiment, the sensing device 212 may include one or more biometric sensors to track one or more biometric characteristics, such as movement of the eyes of the user 104.

In operation, the processor 202 in the electronic device 102 may be operable to execute an application. Such an application may be requested by the user 104 and hosted by the service provider 106. The application may be streamed by the service provider 106 to the electronic device 102 via the communication network 108 and the transceiver 208. The processor 202 may be operable to execute the requested application in a first mode. In an embodiment, the first mode may be a visual mode. In the visual mode, an interface corresponding to the requested application is displayed by the processor 202 on the display screen 112. In an embodiment, the first mode may be a non-visual mode. In the non-visual mode, the requested application is streamed to the electronic device 102 and played by the microphone of the electronic device 102.

The sensing device 212 may be operable to detect one or more conditions with respect to the electronic device 102. Examples of the one or more conditions may include, but are not limited to, ambient light, ambient noise, motion detection, battery usage status, and/or power supply status.

The sensing device 212 may be further operable to determine one or more parameters associated with each of the detected one or more conditions. For example, for the ambient illumination condition, the one or more determined parameters may be a luminous intensity, a density of luminous intensity in a given direction, a luminous flux, luminous power per area, a color rendering index (CRI), a gamut area index (GAI), and/or the like. For the ambient noise condition, the one or more determined parameters may be a sound pressure level, a sound energy flux, a sound intensity level, an acoustic intensity level, and/or the like. For the motion detection, the one or more determined parameters may be an accelerative force, a velocity, an orientation, and/or a tilt angle of the electronic device 102. For the battery usage status condition, the one or more determined parameters may be an amount of battery used, an amount of battery remaining, and/or a critical battery level. For the power supply status condition, the one or more determined parameters may be a power supply level, and/or a time and an amount of power supply required to completely charge the battery of the electronic device 102.

The comparator 204 may be operable to compare the determined one or more parameters associated with each of the detected one or more conditions, with corresponding pre-determined threshold values. In an embodiment, such pre-determined threshold values may be pre-specified by the user 104 and stored in the memory 206. In an embodiment, such pre-determined threshold values may be automatically determined by the processor 202 and stored in the memory 206. Based on the comparison, the processor 202 may be operable to switch a mode of the electronic device 102 from the first mode to a second mode. In an embodiment, when the first mode is a visual mode, the second mode is a non-visual mode. In an embodiment, when the first mode is a non-visual mode, the second mode is a visual mode.

In an embodiment, the processor 202 may be operable to switch from the first mode to the second mode based on a manual input. In such an embodiment, the electronic device 102 may wait to receive one or more input values from the user 104 to initiate manual switching mode. The one or more input values may be a pre-specified input and may include an audio-based input, a touch-based input, and/or a gesture-based input. For example, the processor 202 may wait to receive a pre-specified pattern of finger clicks from the user 104. The sensing device 212 may be operable to detect the pre-specified number of finger clicks from the user 104 and transmit a signal to the processor 202. The processor 202, based on the received signal, confirms the pre-specified input received from the user 104 and switches from the first mode to the second mode.

In an embodiment, the processor 202 may be operable to switch from the first mode to the second mode automatically. In such an embodiment, the electronic device 102 may not require any user intervention from the user 104. In such an embodiment, the sensing device 212 may be operable to detect one or more pre-determined events. When the sensing device 212 detects the one or more pre-determined events, the sensing device 212 may transmit a signal to the processor 202. The processor 202, based on the received signal, may confirm the pre-determined events and switch from the first mode to the second mode.

In an exemplary embodiment, the sensing device 212 may be operable to track the eye movement of the user 104. The sensing device 212 may detect that the user 104 is looking away from the electronic device 102 and may transmit a signal to the processor 202 to switch the mode of the electronic device 102 from a visual mode to a non-visual mode.

In another exemplary embodiment, the electronic device 102 is automatically switched from the visual mode to the non-visual mode when the sensing device 212 detects that the user 104 is visually impaired. The sensing device 212 may detect such a visual impairment of the user 104 based on one or more biometric characteristics of the user 104. The sensing device 212 may transmit a signal to the processor 202 to switch the mode of the electronic device 102 from a visual mode to a non-visual mode.

When the electronic device 102 is switched to the second mode, the processor 202 may be operable to indicate that the electronic device 102 is being switched to the second mode. The indication may include one or more of an audio-based output, a message, a graphical icon, or a tactile output. In an instance, when the second mode is a non-visual mode, the indication may be one or more of a pre-determined number of vibrations, an audio-based message (such as, “Turning the device to video-free mode”), and/or the like. In another embodiment, when the second mode is a visual mode, the indication may be a display of a graphical icon, a written text (such as, “Turning the device to audio-free mode”), and/or the like.

When the electronic device 102 is switched to the second mode, the user 104 may provide a user input to the electronic device 102. The user input may be one or more of an audio-based input, a touch-based input, or a gesture-based input. When the second mode is a visual mode, the user input may be spoken words, such as, “Check Mail Please”. In another instance, when the second mode is a non-visual mode, the user input may be a combination of a button-press event and one or more gestures, such as a winking gesture.

In response to the user input, the electronic device 102 may be operable to output a second response in the second mode. The second response may correspond to a first response in the first mode. For example, for the user input, “Check Mail Please”, the second response may be an audio recitation of new mails from the inbox via the microphone of the electronic device 102.

The processor 202 may be further operable to perform an action and generate the non-visual response, which corresponds to the user input. An association between the action and the user input may be pre-configured by the user 104 in the visual mode. For example, for the user input, “Check Mail Please”, the action may be opening the inbox to check the new mails. Corresponding to the action performed, the audio recitation of the new mails from the inbox is generated. Such an association between the action and the user input may be pre-configured by the user 104, while in the first mode.

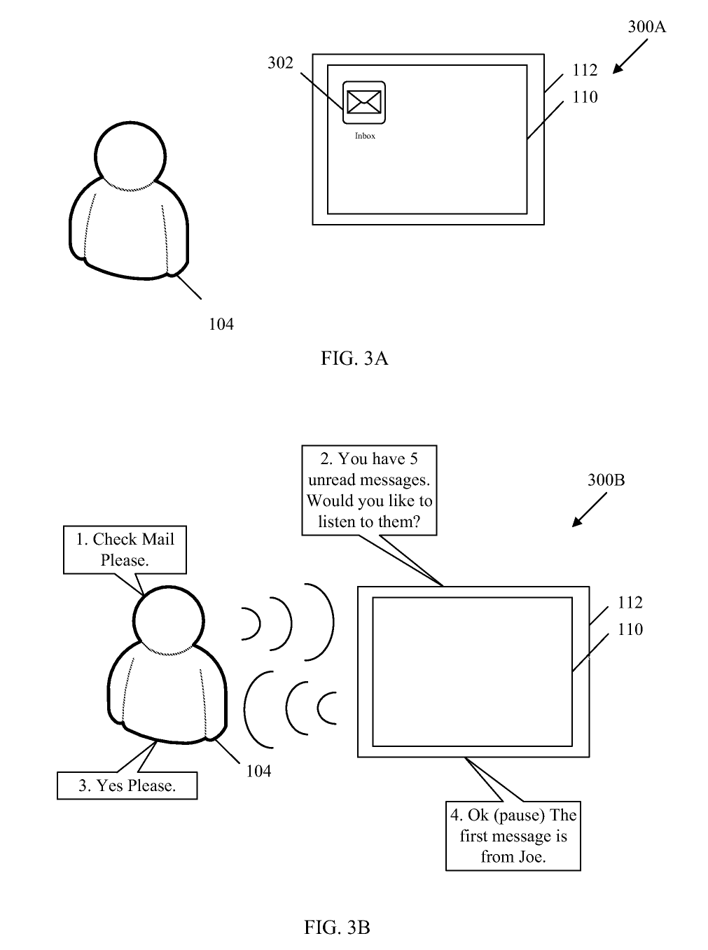

FIGS. 3A and 3B are respective diagrams 300A and 300B, illustrating a first exemplary scenario for switching a mode of an electronic device, in accordance with an embodiment of the disclosure. The diagrams 300A and 300B of FIGS. 3A and 3B are described in conjunction with the block diagrams of FIG. 1 and FIG. 2, respectively. With reference to FIGS. 3A and 3B, there is shown the user 104 having an interaction with the electronic device 102 in a visual mode. The electronic device 102 may include the display screen 112, operable to display a graphical user interface (GUI) 110, which corresponds to an internet-based messaging application 302. The user 104 may provide an input to the electronic device 102 via the GUI 110. For example, the user 104 may use the GUI 110 to navigate through the inbox to check his mail, based on one or more of: an audio-based input, a touch-based input, or a gesture-based input. Notwithstanding, the disclosure may not be so limited and the user 104 may perform any operation on any application in the electronic device 102.

In accordance with the first exemplary scenario, the user 104 may experience a sudden change in ambient conditions, such as a sudden increase in ambient illumination. The sensing device 212 in the electronic device 102 may be operable to automatically detect such a sudden increase in the ambient illumination. Accordingly, the user 104 may not be able to view the GUI 110, which corresponds to the internet-based messaging application 302. In response to the automatic detection, the processor 202 may be operable to switch the electronic device 102 from the visual mode to a non-visual mode, such as an audio-only mode. The processor 202 may be operable to non-visually indicate that the electronic device 102 is being switched to the non-visual mode, such as with one or both of: an audio output (such as, “Device now in video-free mode”), and a vibration signal.

In the non-visual mode, the user 104 may provide a user input, such as an audio-based input, “Check Mail Please”, to the electronic device 102 via the I/O device 210, (such as a microphone). The processor 202 may be operable to receive the user input and perform an action for the received user input. In the exemplary scenario, the action may be checking the inbox for new mail. The action may further generate a non-visual response, which corresponds to the user input, such as the audio output, “You have 5 unread messages. Would you like to listen to them?” An association between the action and the user input is pre-configured by the user 104 in the visual mode.

In response to the audio output generated by the electronic device 102, the user 104 may provide another user input, “Yes Please”. The processor 202 may be operable to generate an audio output in response to the action being performed with respect to the previous user input. In parallel to the checking of the inbox for the new mail, the processor 202 may be operable to output another audio output, such as, “Ok (pause) the first message is from Joe . . . ”

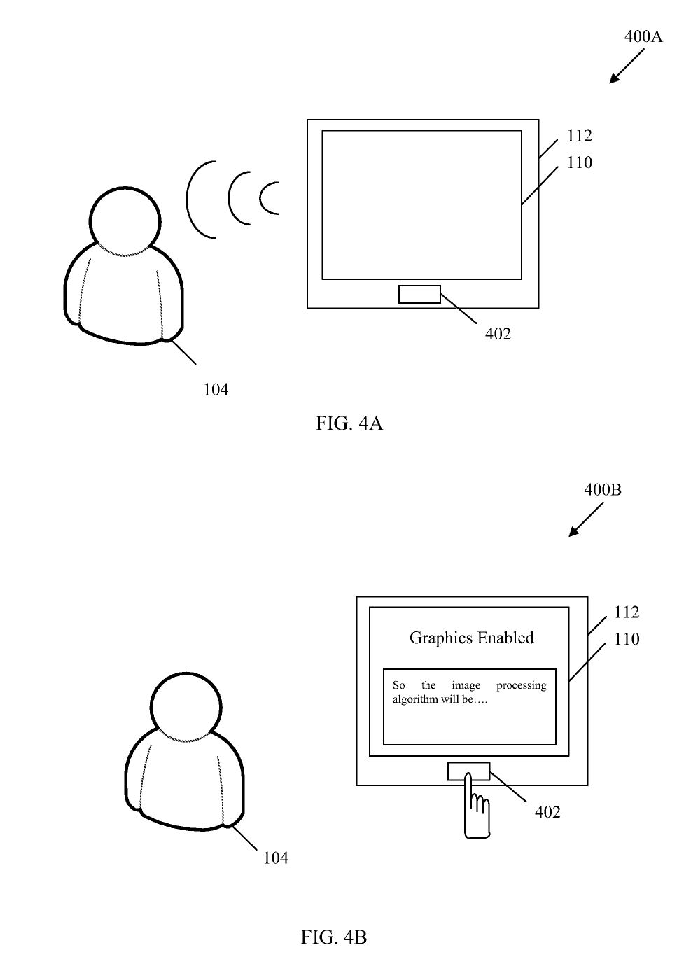

FIGS. 4A and 4B are respective diagrams 400A and 400B, illustrating a second exemplary scenario for switching a mode of an electronic device, in accordance with another embodiment of the disclosure. The diagrams 400A and 400B of FIGS. 4A and 4B are described in conjunction with the block diagrams of FIG. 1 and FIG. 2, respectively. With reference to FIGS. 4A and 4B, there is shown the user 104 having an interaction with the electronic device 102 in a non-visual mode. The electronic device 102 may include the I/O device 210, such as an audio speaker, operable to provide an audio output of a tutor delivering a lecture in an online tutorial. The online tutorial may be hosted by the service provider 106.

In accordance with the second exemplary scenario, the user 104 may experience a sudden change in ambient conditions, for example a sudden increase in ambient noise. The sensing device 212 in the electronic device 102 may be operable to automatically detect such a sudden increase in the ambient noise. Consequently, the user 104 may not be able to listen to the tutor. In response to the automatic detection, the processor 202 may be operable to switch the electronic device 102 from the non-visual mode to a visual mode, such as a video-only mode. The processor 202 may be operable to visually indicate that the electronic device 102 is being switched to the visual mode, for example display of a message, “Graphics Enabled” on the GUI 110.

In the visual mode, the user 104 may provide a user input to the electronic device 102, via a button-press input of a physical device button 402. The processor 202 may be operable to receive the user input and perform an action for the received user input. In the exemplary scenario, the action may be a transcription of the audio content spoken by the tutor to a text. The action may further generate a visual response, which corresponds to the user input. The visual response, which corresponds to the transcribed text, may be displayed on the display screen 112 as, “So the image processing algorithm will be . . . ” Such a visual response is displayed on the display screen 112 by the presentation engine 202a. An association between the action and the user input is pre-configured by the user 104 in the non-visual mode.

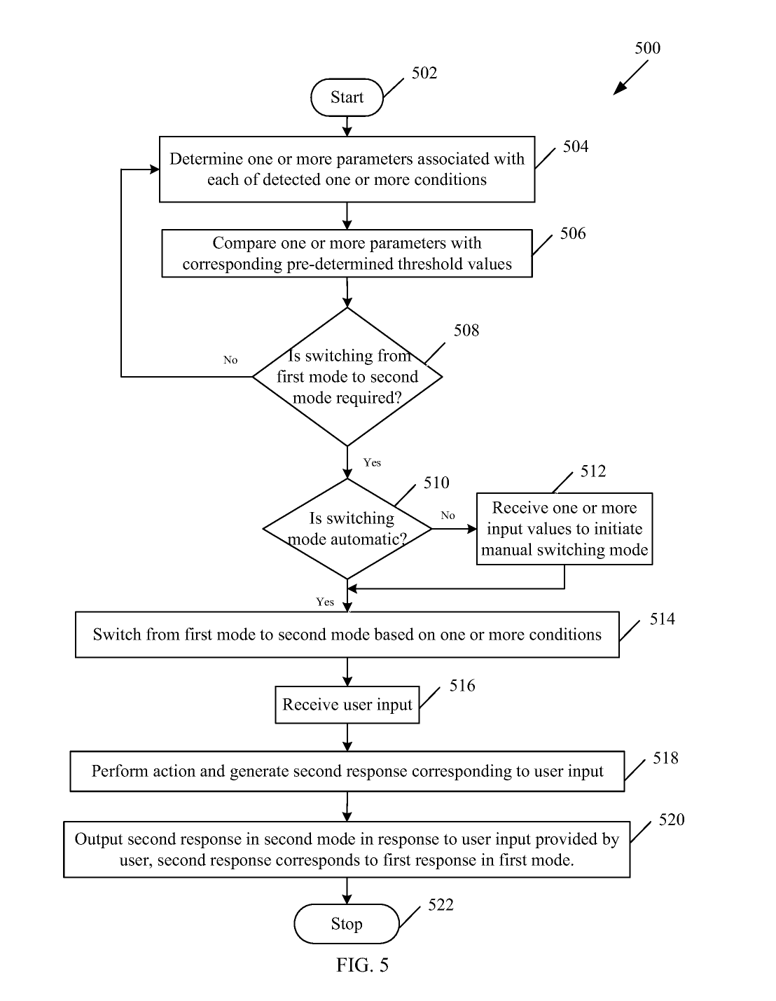

FIG. 5 is a flowchart illustrating a method for switching a mode of an electronic device, in accordance with an embodiment of the disclosure. FIG. 5 is described in conjunction with elements of FIG. 1 and FIG. 2. The method 500 may be implemented in the electronic device 102 in a first mode, which is communicatively coupled to the service provider 106 via the communication network 108.

The method 500 begins at step 502 and proceeds to step 504. At step 504, one or more parameters associated with each of detected one or more conditions, such as ambient illumination, may be determined.

At step 506, the determined one or more parameters associated with each of the detected one or more conditions may be compared with corresponding pre-determined threshold values stored in the memory 206. At step 508, it may be determined, based on the comparison, that the electronic device 102 is required to be switched from the first mode to a second mode. In instances where the electronic device 102 is not required to be switched from the first mode to the second mode, control proceeds back to step 504. In instances where the electronic device 102 is required to be switched from the first mode to the second mode, control proceeds to step 510.

At step 510, it may be determined whether the switching mode is manual or automatic, based on a flag set in the memory 206. In instances where the switching mode is automatic, control proceeds directly to step 514. In instances where the switching mode is manual, control proceeds to step 512. At step 512, one or more input values may be received from the user 104 to initiate manual switching mode. Control then proceeds to step 514.

At step 514, the first mode may be switched to a second mode, based on the detected one or more conditions. Further, it may be indicated, in the second mode, that the electronic device 102 is being switched to the second mode.

At step 516, an input may be received from the user 104. At step 518, an action may be performed and a second response may be generated. The generated second response may correspond to the received user input. An association between the action and the user input may be pre-configured by the user 104, while the electronic device 102 is in the first mode.

At step 520, the second response in the second mode may be output, in response to the user input provided by the user 104. The second response may correspond to a first response in the first mode pre-configured by the user 104, while the electronic device 102 is in the first mode. Control then passes to end step 522.

In accordance with an embodiment of the disclosure, a system for switching a mode of the electronic device 102 (FIG. 1) is disclosed. The electronic device 102 may comprise one or more processors and/or circuits, such as the processor 202 (FIG. 2), in the electronic device 102. The processor 202 may be operable to switch the electronic device 102 from a first mode to a second mode in response to detecting one or more conditions. The processor 202 may be further operable to output a second response in the second mode in response to a user input provided by the user 104 (FIG. 1). The second response may correspond to a first response in the first mode.

Various embodiments of the disclosure may provide a non-transitory computer readable medium and/or storage medium, and/or a non-transitory machine readable medium and/or storage medium having stored thereon, a machine code and/or a computer program having at least one code section executable by a machine and/or a computer for switching a mode of an electronic device. The at least one code section in an electronic device, associated with a user, may cause the machine and/or computer to perform the steps comprising switching the electronic device from a first mode to a second mode in response to detecting one or more conditions, and outputting a second response in the second mode in response to a user input provided by a user. The second response may correspond to a first response in the first mode.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that may include a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method comprising:
in an electronic device:
switching said electronic device from a first mode to a second mode in response to detecting one or more conditions; and
outputting a second response in said second mode in response to user input, wherein said second response corresponds to a first response in said first mode.

2. The method according to claim 1, further comprising performing an action and generating said second response corresponding to said user input, wherein an association between said action and said user input is pre-configured by a user in said first mode.

3. The method according to claim 1, further comprising comparing one or more parameters associated with said one or more conditions with corresponding pre-determined threshold values.

4. The method according to claim 3, wherein said switching from said first mode to said second mode is based on said comparison.

5. The method according to claim 1, wherein said one or more conditions comprise one or more of: an ambient light, an ambient noise, motion detection, a battery usage status, and/or a power supply status.

6. The method according to claim 1, wherein said user input is one of: an audio-based input, a touch-based input, or a gesture-based input.

7. The method according to claim 1, wherein said first mode is a visual mode and said second mode is a non-visual mode.

8. The method according to claim 7, further comprising turning off a display of said electronic device in said non-visual mode.

9. The method according to claim 7, further comprising indicating in said second mode that said electronic device is being switched to said second mode, wherein said indication comprises one or more of: an audio-based output or a tactile output.

10. The method according to claim 1, wherein said first mode is a non-visual mode and said second mode is a visual mode.

11. The method according to claim 10, further comprising indicating in said second mode that said electronic device is being switched to said second mode, wherein said indication comprises one or more of: a message and/or a graphical icon.

12. A system comprising:
one or more processors in an electronic device operable to:
switch said electronic device from a first mode to a second mode in response to detecting one or more conditions; and
output a second response in said second mode in response to user input, wherein said second response corresponds to a first response in said first mode.

13. The system according to claim 12, wherein said one or more processors are operable to compare one or more parameters associated with said one or more conditions with corresponding pre-determined threshold values.

14. The system according to claim 13, wherein said one or more processors are operable to switch from said first mode to said second mode based on said comparison.

15. The system according to claim 12, wherein said one or more processors are operable to perform an action and generate said second response corresponding to said user input, wherein an association between said action and said user input is pre-configured by a user in said first mode.

16. The system according to claim 12, wherein said first mode is a visual mode and said second mode is a non-visual mode.

17. The system according to claim 16, wherein said one or more processors are operable to indicate in said second mode that said electronic device is being switched to said second mode, wherein said indication comprises one or more of: an audio-based output or a tactile output.

18. The system according to claim 12, wherein said first mode is a non-visual mode and said second mode is a visual mode.

19. The system according to claim 18, wherein said one or more processors are operable to indicate in said second mode that said electronic device is being switched to said second mode, wherein said indication comprises one or more of: a message and/or a graphical icon.

20. A non-transitory computer-readable storage medium having stored thereon, a computer program having at least one code section for switching, the at least one code section being executable by a computer for causing the computer to perform steps comprising:
in an electronic device:
switching said electronic device from a first mode to a second mode in response to a detecting of one or more conditions; and
outputting a second response in said second mode in response to user input provided by a user, wherein said second response corresponds to a first response in said first mode.
